(19) United States
(12) Patent Application Publication
(10) Pub. No.: US 2006/0215756 A1
(43) Pub. Date: Sep. 28, 2006

(54) Decoding circuit and decoding method

(75) Inventor: Michihiro Fukushima, Fuchu-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/386,711

(22) Filed: Mar. 23, 2006

(30) Foreign Application Priority Data
Mar. 25, 2005 (JP) 2005-088378

(51) Int. Cl. H04N 7/12; H04N 11/04; H04N 11/02; H04B 1/66

(52) U.S. Cl. 375/240.12; 375/240.01

(57) ABSTRACT

A decoding circuit has first decoding section which receives first compressed image information, decodes the information, and outputs decoded image information, second decoding section which receives the first compressed image information or second compressed image information, decodes the information, and outputs decoded image information, buffer section which stores the decoded image information in storage region, and control section which responds to an instruction signal, if given, when the first decoding section is decoding the compressed image information by using storage region having first capacity of storage regions of the buffer section and outputting it to first output terminal, to thereby control the first and second decoding sections so that the second decoding section decodes and outputs the first or second compressed image information by using a storage region having second capacity smaller than the first capacity of the storage regions of the buffer section.

### CROSS-REFERENCE TO RELATED APPLICATIONS

This application is based upon and claims the benefit of priority from Japanese Patent Application No. 2005-088378, filed Mar. 25, 2005, the entire contents of which are incorporated herein by reference.

### BACKGROUND

1. Field

The present invention relates to an image information decoding circuit and more particularly to a decoding circuit and a decoding method that specify a method for using a decoding buffer, in which the decoding circuit has a plurality of decoding functions to decode one or a plurality of compressed image information pieces.

2. Description of the Related Art

Recently, digital technologies have been used widely, accompanying which moving picture information compression/decompression technologies such as, for example, moving picture expert group (MPEG) technologies have been utilized also in a variety of image information appliances such as a digital TV and a digital versatile disk (DVD) player.

As one of such prior arts, Patent Document 1 (Jpn. Pat. Appln. KOKAI Publication No. 11-112931) discloses a technology for efficiently decoding an encoded string of a DVD-standard sub-video by using a minimum required storage capacity, thereby obtaining sub-video information. This technology is thought of as having been developed to process MPEG information.

However, the prior art of Patent Document 1 is of processing to decode a main video and a sub-video, thus referring to only processing to decode one image information piece. Further, this literature discloses nothing in particular about how to reduce a buffer capacity when performing this decoding processing. Therefore, this prior art has a problem that information cannot be decoded for video recording at the same time as reducing the buffer capacity. It has another problem that a plurality of video information pieces cannot be decoded at the same time as reducing the buffer capacity.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a transition diagram of one example of transition of a decoding buffer region in one-screen display which is utilized by a decoding circuit related to one embodiment of the present invention;

FIG. 2 is a transition diagram of one example of transition of the decoding buffer region in two-screen display which is utilized by the decoding circuit;

FIG. 3 is a transition diagram of one example of transition of the decoding buffer region in one-screen display and two-screen display which are used by the decoding circuit;

FIG. 4 is a block diagram of one example of a configuration of the decoding circuit;

FIG. 5 is a block diagram of one example of a configuration of a TV set or an image recording/reproducing apparatus to which the decoding circuit is applied;

FIG. 6 is a flowchart of one example of processing of the decoding buffer in a case where the decoding circuit performs one-screen display; and

FIG. 7 is a flowchart of one example of processing of the decoding buffer in a case where the decoding circuit performs one-screen display and two-screen display.

### DETAILED DESCRIPTION

Various embodiments according to the invention will be described hereinafter with reference to the accompanying drawings. In general, according to one embodiment of the invention, a decoding circuit comprising: a first decoding section which receive first compressed image information, decodes the information, and outputs decoded image information; a second decoding section which receives the first compressed image information or second compressed image information, decodes the information, and outputs decoded image information; a buffer section which stores the decoded image information in a storage region; and a control section which responds to an instruction signal, if given, when the first decoding section is decoding the first compressed image information by using a storage region having a first capacity of storage regions of the buffer section and outputs it to a first output terminal, to thereby control the first decoding section and the second decoding section so that the second decoding section decodes and outputs the first compressed image information or the second, compressed image information by using a storage region having a second capacity smaller than the first capacity of the storage regions of the buffer section.

The following will describe embodiments of the present invention with reference to drawings.

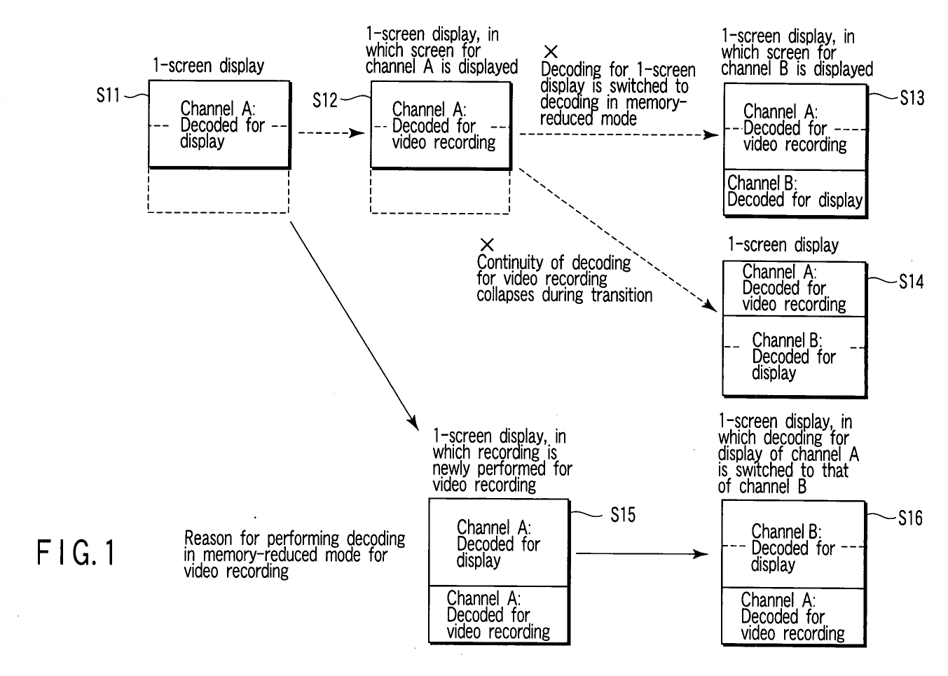

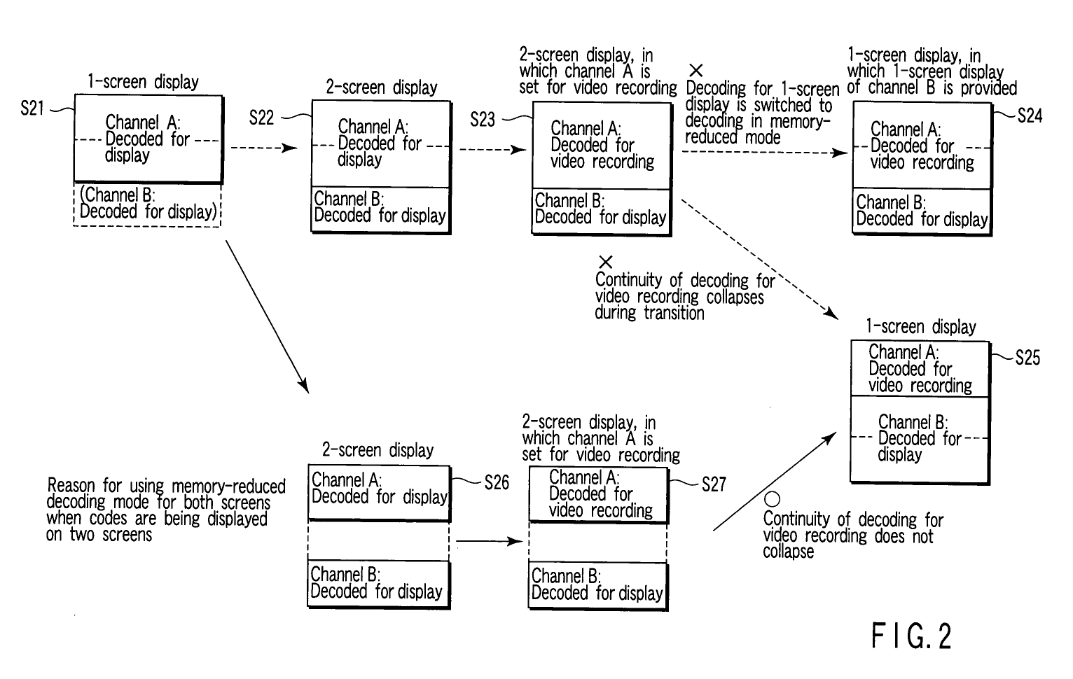

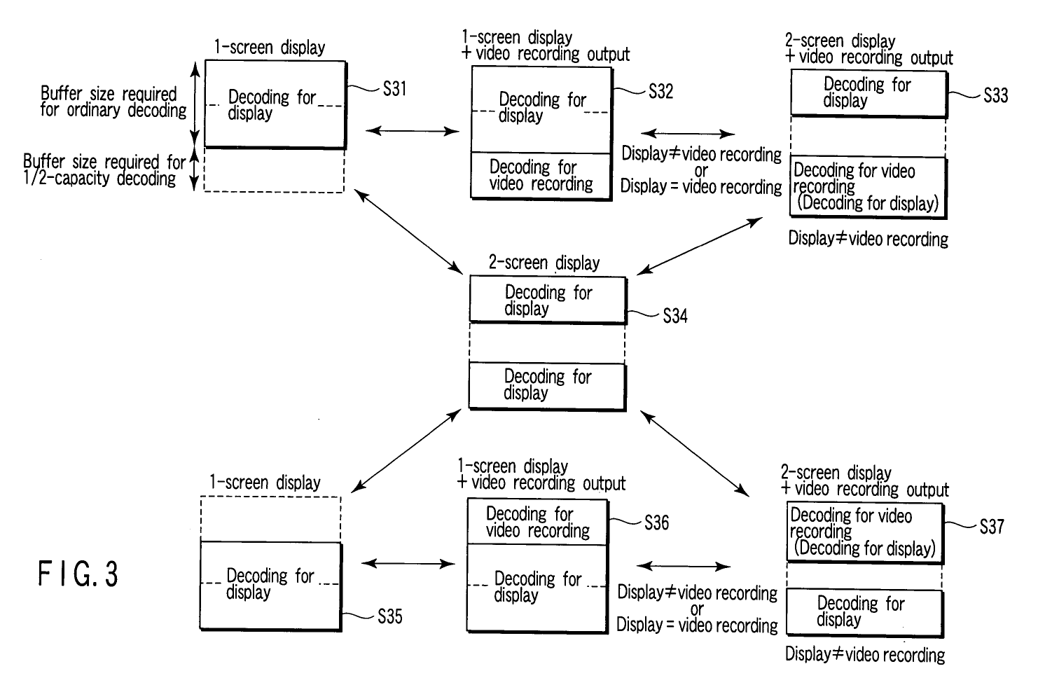

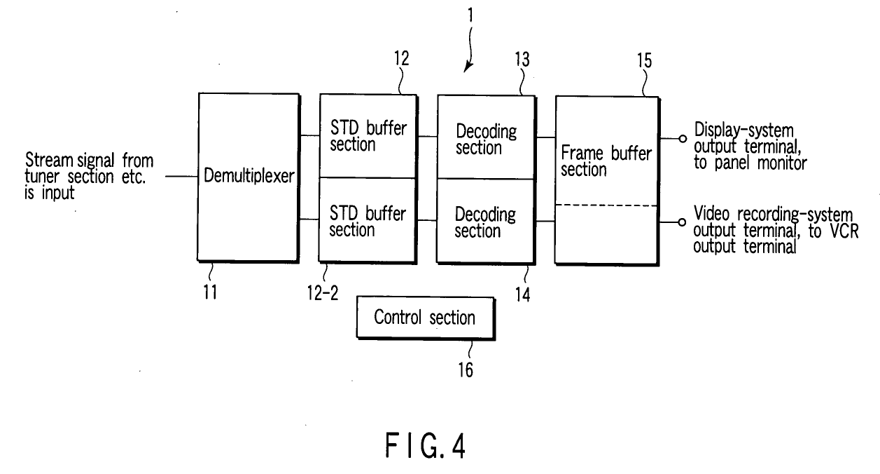

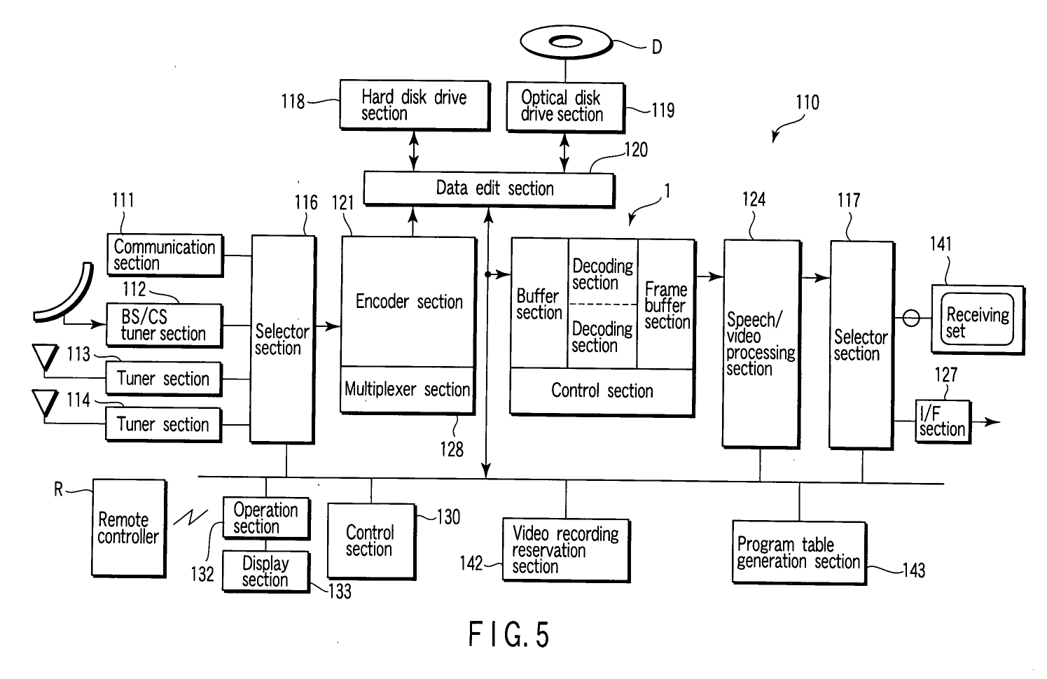

FIG. 1 is a transition diagram of one example of transition of a decoding buffer region in one-screen display which is utilized by a decoding circuit related to one embodiment of the present invention. FIG. 2 is a transition diagram of one example of transition of the decoding buffer region in two-screen display which is utilized by the decoding circuit. FIG. 3 is a transition diagram of one example of transition of the decoding buffer region in one-screen display and two-screen display which are utilized by the decoding circuit. FIG. 4 is a block diagram of one example of a configuration of the decoding circuit. FIG. 5 is a block diagram of one example of a configuration of a TV set or an image recording/reproducing apparatus to which the decoding circuit is applied.

<Decoding Circuit According to One Embodiment of the Present Invention>

(Features)

A decoding circuit according to one embodiment of the present invention has a plurality of decoding functions and, in one example thereof, may be used as a decoder for compressed TV image information. That is, first this decoding circuit decodes an MPEG stream etc. by using a first-capacity storage region of storage regions of a buffer section based on image information that provides a video to be broadcast through a desired channel, which decoded image information is supplied to a display etc. so that it may be reproduced on a screen. In such a situation, if a further operation of a user etc. instructs to video-record the image information that provides the broadcast video of this channel, rather than outputting to a recorder etc. an image signal of the image information already decoded for the purpose of reproduction on the screen, this circuit uses another decoding function to perform decoding by using, for example, half a buffer capacity of an ordinary mode in a so-called memory-reduced mode.

By thus utilizing the ordinary mode that uses an ordinary capacity and the memory-reduced mode that uses half the capacity while performing a plurality of decoding processing items, it is possible to suppress the buffer capacity to, for example, twice through 1.5′th times the ordinary capacity. Further, if a video recording operation is performed, correspondingly decoding processing is performed in the memory-reduced mode, so that even if a screen display channel is changed subsequently, the decoding processing for video recording in the memory-reduced mode will continue.

That is, such a case is assumed that first the user views contents of channel A on the screen and performs a video recording operation to thereby supply decoded information of the channel A contents to an external recorder etc. in a video recording mode and, then, switches the screen to channel B while continuing to video-record the channel A contents. In this case, decoding processing continues as it is in the memory-reduced mode, so that the processing of video-recording the channel A contents does not encounter a trouble such as disturbance in the video-recording screen. Moreover, the memory-reduced mode can be utilized, so that it is possible to realize a plurality of decoding processing items at the same time as suppressing the memory capacity as a whole.

(Configuration)

As shown in FIG. 4, a decoding circuit 1 according to one embodiment of the present invention is configured to comprise a demultiplexer 11 to which a stream signal is input from an external tuner etc. (which may be an input terminal not shown), STD buffer sections 12 and 12-2 to which output terminals of the demultiplexer 11 are connected respectively, decoding sections 13 and 14 which are connected to these STD buffers respectively, and a frame buffer section 15 which has a storage region that is used by each of the decoding sections 13 and 14 when it performs decoding processing. Further, one of two outputs of the frame buffer 15 is supplied via a display-system output terminal, not shown, to a display-system panel monitor. Alternatively, it is supplied to the display-system output terminal and then via a speech/video processing section 124 of FIG. 5 to a receiving set 141. The other output of the frame buffer section 15 is supplied via a video recording-system output terminal to a VCR output terminal not shown. Alternatively, it is supplied to the video recording-system output terminal and then via the speed/video processing section 124 of FIG. 5 to an I/F section 127 or via a built-in selector section 116, an encoder section 121, and a data edit section 120 to a hard disk drive 118.

Although the decoding circuit 1 according to one embodiment of the present invention can be realized in the above-described configuration given as one example, the circuit may be configured in a logic circuit etc. having desired functions or a microcomputer system that contains a microcomputer and an RAM, an ROM, etc. in which operating programs are stored.

The decoding circuit 1 of one embodiment of the present invention can be built in any apparatus. However, it may be applied most suitably to such apparatuses as, but not limited to, a TV set having one or a plurality of tuner sections especially such as shown in FIG. 5, a TV set having a function to record and reproduce a stream signal, a recording/reproducing apparatus having one or a plurality of tuner sections, etc. Further, the stream signal need not always be supplied from the built-in tuner section but may be given from an external input terminal of a TV set etc. or from a recording section built in a TV set etc.

(TV Set to Which a Decoding Circuit According to One Embodiment of the Present Invention can be Applied)

The following will describe in detail one example of a configuration of a TV set to which a decoding circuit according to one embodiment of the present invention can be applied, with reference to FIG. 5. FIG. 5 shows one example of such a configuration of a general-purpose type TV set as to have a built-in stream recording function in addition to original TV functions as more general video processing apparatus.

That is, in the TV set of FIG. 5, a control section 130 is connected to each 110 section through a data bus in order to govern overall operations, mainly comprising a decoding section 1 that configures the side of reproduction, the control section 130 for controlling operations of the apparatus body, the encoder section 121 that configures the side of video recording, and a multiplier section 128. The TV set 110 has an input side selector 116 and an output side selector 117. The input side selector 116, to which a communication section 111 such as an LAN, a so-called satellite broadcast (BS/CS) tuner section 112, and a so-called ground-wave tuner sections 113 and 114, supplies a stream signal to the decoding section 1. Further, a satellite antenna is connected to the BS/CS tuner section 112, and a ground-wave antenna is connected to the ground-wave tuner section 113. Further, the TV set 110 has the data edit section 120 for performing desired data processing such as data edition etc., a hard disk drive section 118 connected to the data edit section 120, and an optical disk drive section 119. The TV set 110 further has a video recording reservation section 142, a program table generation section 143 for generating a reservation list or a program table image, etc. These sections are connected to the control section 130 via the data bus. An output of the selector section 117 is supplied to the receiving set 141. An output of the selector section 117, on the other hand, is supplied to an external apparatus via an interface section 127 for performing communications with the external apparatus. It further has a hard disk drive section 118 for driving a hard disk as a second medium.

The TV set 110 further has an operation section 132 that is connected to the control section 130 via the data bus and receives an operation of the user and an operation of a remote controller R. It is to be noted that the remote controller R enables almost the equivalent operations as the operation section 132 mounted on the body of the TV set 110, specifically enabling an instruction to record and reproduce contents at the hard disk drive section 118 and the optical disk drive 119, an edit instruction, an operation of the tuner, and a variety of settings such as that of video recording reservation.

In the TV set 110 having such a configuration, according to an operation of the remote controller R etc. by the user, video streams through one or the plurality of tuner sections 112-114 are appropriately decoded by the decoding section 1 and supplied to the receiving set 141, the external terminal 127, or the built-in drive sections 118 and 119 of the subsequent-stages so that an video may be reproduced (or recorded).

(Decoding Processing Peculiar to One Embodiment of the Present Invention)

That is, the decoding circuit 1 according to one embodiment of the present invention decodes a stream etc. obtained by receiving, for example, a digital broadcast and displays it on a TV screen etc. The decoding circuit 1 can decode at least two streams simultaneously, to provide one-screen display (which displays one of decoded results on the screen) of the decoded results (video output) on the TV screen or two-screen display (which simultaneously displays results of decoding two streams on the screen). Further, the decoding circuit 1 has an output function (including a function to output an analog video and a function to encode contents again and output them digitally) to output contents to a video recording appliance such as a VCR for video recording.

Besides the ordinary decoding mode, the decoding circuit 1 according to one embodiment of the present invention further has such a mode (referred to as a memory-reduced mode) as to decode a stream signal by using a smaller-sized buffer memory than a storage capacity used in the ordinary decoding mode.

The memory-reduced mode, as used herein, refers to a mode for decoding contents by, for example, halving an original horizontal size of reference images (front/rear reference images) which is required when decoding a stream encoded by using, for example, the MPEG2 standard and also halving a horizontal size of the decoded images, so that any other approach can be used as far as it enables decoding by use of a memory size smaller than that required in the ordinary decoding mode.

<Decoding Processing on One Screen>

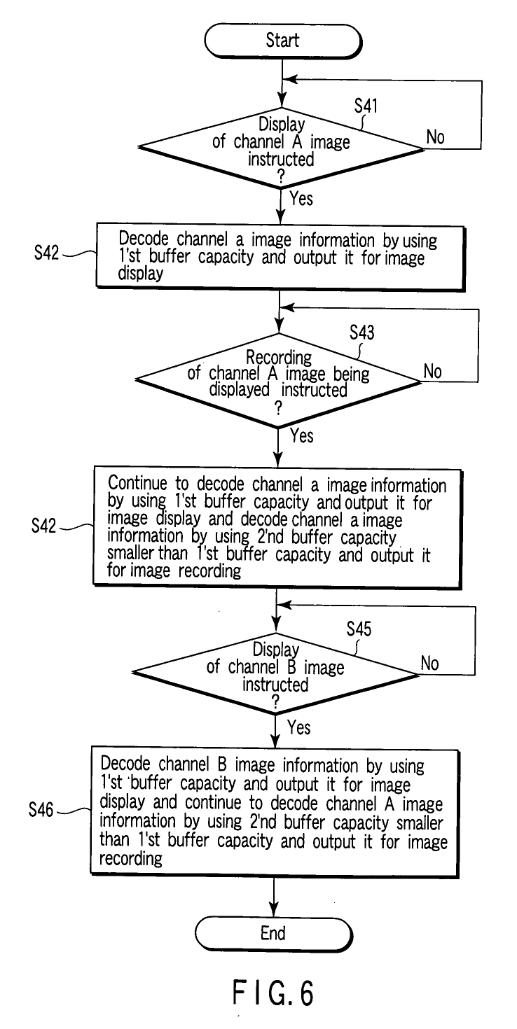

The following will describe a specific example of decoding processing performed by the decoding circuit according to one embodiment of the present invention, with reference to the transition diagram of FIG. 1 and a flowchart of FIG. 6. FIG. 6 shows the flowchart of one example of processing of the decoding buffer in a case where the decoding circuit performs one-screen display.

Trouble in the case of not using transition processing according to one embodiment of the present invention

Before describing processing of a decoding circuit 101 applied as part of such an assumed apparatus as a TV set shown in FIG. 5, a trouble in the memory-reduced mode in the case of not using transition processing according to one embodiment of the present invention is described by using the transition diagram of FIG. 1.

That is, as shown in FIG. 1, such a case is assumed that in the TV set 110 shown in FIG. 5, a stream signal (e.g., MPEG stream) for channel A supplied from the tuner section 113 etc. is decoded by the decoding section 1 and displayed on one screen at the receiving set 141 etc. In this processing, first, when one-screen display of a stream from the tuner section 113 etc. is being provided (step S11), the decoding section 13 decodes a stream signal supplied via the demultiplexer 11 and the STD buffer 12 by using a full (1/1) storage capacity of the frame buffer section 15. In this case, it is assumed that in response to an operation of the remote controller R etc. by the user to instruct video-recording of a currently viewed screen, the signal has been decoded to be output for video recording by using the full (1/1) storage capacity of the frame buffer section 15 (step S12). Subsequently, it is assumed that the user has operated the remote controller R etc. again to instruct screen-display of contents for channel B at the receiving set 141 etc. (step S23).

In this case, if such a user's operation is accommodated by reducing a total storage capacity of the frame buffer 15 to 3/2 (= 1/1+½), the contents for channel B are decoded by using half the storage capacity (step S13), to rapidly deteriorate an image quality of the display screen because channel A is switched to channel B, thereby resulting in the processing unsatisfactory for the user.

On the other hand, if in response to an operation to switch to channel B at step S12 the processing is performed by using half (½) the storage capacity of the frame buffer 15 for the channel A contents and using the full ( 1/1) storage capacity of the frame buffer section 15 for the channel B contents (step S14), an image of channel A being video-recorded may be interrupted temporarily upon switchover from the 1/1-storgae capacity processing to the ½-storage capacity processing, thereby giving rise to a trouble of damaged continuity of the video.

Case of Using Transition Processing According to One Embodiment of the Present Invention

In view of the above, the following will describe transition processing peculiar to the decoding circuit for performing a plurality of decoding processing items in the memory-reduced mode while avoiding these troubles, with reference to the flowchart of FIG. 6. Although these operations are described, as given in the following one embodiment, with reference to an example where the decoding circuit 1 according to one embodiment of the present invention is applied as, for example, the decoding circuit 101 in the TV set 110, the embodiments of the present invention are not limited to it but the circuit 101 may be applicable to any cases as far as it is mounted in an apparatus required to perform a plurality of decoding processing items.

As shown in the transition diagram of FIG. 1 and the flowchart of FIG. 6, to accommodate a user's operation under the control of the control section 130 in the TV set, first the decoding circuit 1 decides whether display of image A is instructed in the TV set 110 under the control of a control section 16 (step S41). If such is the case, a stream signal given by the tuner section 113 is provided to the demultiplexer 11 and supplied via the STD buffer section 12 to the decoding section 13. The decoding section 13 decodes information of image A by using a first buffer capacity ( 1/1: storage capacity is not reduced) of the frame buffer section 15 and outputs it to the display-system output terminal so that image display may be provided (step S42). Accordingly, an image in accordance with channel A is displayed on the receiving set 141.

Next, for example, if an instruction due to an operation etc. of the remote controller R by the user is given to video-record the channel A image currently being displayed (step S43), a control signal in accordance with this instruction signal is received by the control section 130 in the TV set 110. Then, the control section 130 supplies the corresponding control signal to the control section 16 in the decoding circuit 1. Accordingly, under the control of the control section 16, as shown by step S15 of FIG. 1, processing to decode information of the channel A image is continued by using the first buffer capacity ( 1/1: Storage capacity is not reduced) and a result of the processing is output for image display. Along with this, processing to decode the channel A image information is performed using a second buffer capacity (½: storage capacity is reduced) smaller than the first buffer capacity and a result of the processing is output for image recording to an outside via, for example, the I/F section 127 (step S44). It is to be noted that the ratio of reduction in the second buffer capacity smaller than the first buffer capacity may be ½ but may also take on any other value such as ⅓, ¼, or ¾.

Next, if, in this state, an instruction due to an operation etc. of the remote controller R by the user is given to switch the channel A image being displayed on the receiving set 141 to a B channel image (step S45), as shown by step S16 of FIG. 1, processing to decode the channel B image is performed by using the first buffer capacity ( 1/1) and a result of the processing is output for image display. Along with this, the processing to decode the image A information is continued by using the second buffer capacity (½ etc.) smaller than the first buffer capacity, thereby continuing the output for image recording (step S46).

In such a manner, once the user has given an instruction for video recording, the process continues to decode a desired image in the memory-reduced mode, thereby guaranteeing continuity of the video-recording screen. It is thus possible to avoid the trouble, earlier described with step S14, that continuity of the video-recording screen is damaged when a display screen channel is changed.

On the other hand, if then the user instructs to display an image of a different channel on the screen of the receiving set 141 etc., the processing is performed by using the first buffer capacity ( 1/1) not reduced in capacity. In such a manner, the trouble described earlier with step S13 is avoided that the image quality deteriorates rapidly when the channel is changed.

In such a manner, by the decoding circuit related to one embodiment of the present invention, once a video-recording instruction is received, decoding processing in the memory-reduced mode is newly added to continue supply of a video-recording decode signal, in addition to which, by continuing this decoding processing, the continuity of the recorded image can be guaranteed, and by decoding the display image in the mode where the memory is not reduced in capacity, the image can be displayed without deteriorating its resolution.

<Decoding Processing on Two Screens>

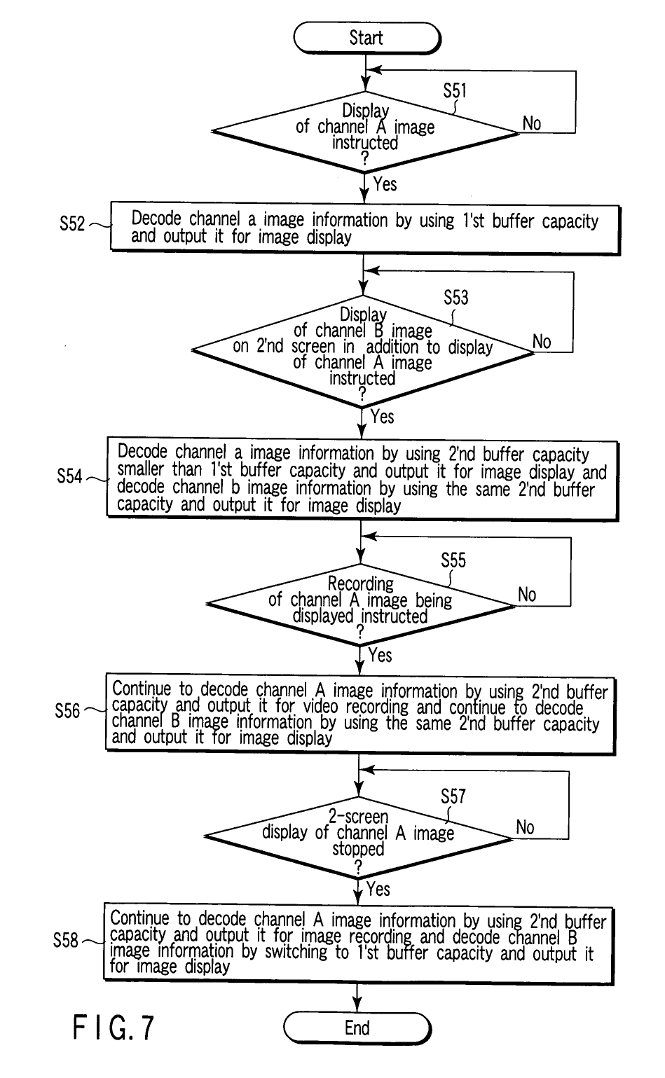

The following will describe decoding processing to accommodate display on two screens by the decoding circuit according to one embodiment of the present invention, with reference to the transition diagrams of FIGS. 2 and 3 as well as a flowchart of FIG. 7. FIG. 7 shows the flowchart of one example of processing of the decoding buffer in a case where the decoding circuit performs two-screen display.

Trouble in the case of not using transition processing according to one embodiment of the present invention

Before describing processing of the decoding circuit 101 applied as part of such an assumed apparatus as the TV set shown in FIG. 5, a trouble in the memory-reduced mode in the case of not using transition processing according to one embodiment of the present invention is described by using the transition diagram of FIG. 2.

That is, as shown in FIG. 2, such a case is assumed that in the TV set 110 shown in FIG. 5, a stream signal (e.g., MPEG stream) supplied from the tuner section 113 etc. is decoded for channel A by the decoding section 1 and displayed on one screen at the receiving set 141 etc. In this processing, first, when one-screen display of a stream from the tuner section 113 etc. is being provided (step S21), the decoding section 13 decodes a stream signal supplied via the demultiplexer 11 and the STD buffer 12 by using a full ( 1/1) storage capacity of the frame buffer section 15.

In this case, it is assumed that in response to an operation of the remote controller R etc. by the user to instruct video-recording of a currently viewed screen, the signal has been decoded to be output for video recording by using the full ( 1/1) storage capacity of the frame buffer section 15 (step S22). Subsequently, it is assumed that the user has operated the remote controller R etc. to set channel A for video recording output.

In this case, such a user's operation is accommodated by reducing the total storage capacity of the frame buffer 15 to 3/2 (= 1/1+½), the contents for channel B are decoded by using half the storage capacity (step S23).

Then, if a user's operation instructs to provide one-screen display of channel B contents, information of the channel B image is decoded and displayed on the screen in the memory-reduced mode using half the storage capacity, thereby resulting in a trouble of the screen having a poor resolution (step S24).

Further, if the process has shifted from step S23 to step S25 in response to a user's operation to instruct provision of one-screen display of channel B contents, it is necessary to switch the 1/1 storage capacity to the ½ storage capacity etc. of the channel A buffer circuit, thereby giving rise to a trouble that the continuity of the image signal for video recording may be lost (step S25).

Case of Using Transition Processing According to One Embodiment of the Present Invention

In view of the above, the following will describe transition processing peculiar to the decoding circuit for performing a plurality of decoding processing items to provide two-screen display by use of the memory-reduced mode while avoiding these troubles, with reference to a flowchart of FIG. 7 as well. Although the following one embodiment is also described with reference to an example where the decoding circuit 1 is applied as, for example, the decoding circuit 101 in the TV set 110, the embodiments of the present invention are not limited to it but the circuit 101 may be applicable to any cases as far as it is mounted in an apparatus required to perform a plurality of decoding processing items.

As shown in the transition diagrams of FIGS. 2 and 3 and the flowchart of FIG. 7, to accommodate a user's operation under the control of the control section 130 in the TV set, first the decoding circuit 1 decides whether display of image A is instructed in the TV set 110 under the control of a control section 16 (step S51). If such is the case, a stream signal given by the tuner section 113 is provided to the demultiplexer 11 and supplied via the STD buffer section 12 to the decoding section 13. The decoding section 13 decodes information of this image A by using the first buffer capacity ( 1/1: storage capacity is not reduced) of the frame buffer section 15 and outputs it to the display-system output terminal so that image display may be provided (step S52). Accordingly, an image in accordance with channel A is displayed on the receiving set 141.

Next the process decides, for example, whether display of a channel B image on a second screen is instructed in addition to the channel A image being displayed according to an operation etc. of the remote controller R by the user (step S53). If, as a result of this decision, display of the channel B image on the second screen is instructed as shown by step S26 of FIG. 2, the process decides the channel A image information by using the second buffer capacity (½ etc.) smaller than the first buffer capacity and outputs it for image display and also decodes information of the channel B image by using the same second buffer capacity (½ etc.) (step S54).

If, further, video-recording of the channel A image being displayed is instructed (step S55), the process continues the processing of decoding the channel A image information by using the second buffer capacity (½ etc.) and outputs it for image display (step S56).

These transitional operations can be understood further intuitively by referencing FIG. 3, persuading that transition is performed from one-screen display of step S31 to two-screen display of step S34 and also bilaterally between the steps.

Further, if two-screen display of the channel A image is stopped by an operation etc. of the remote controller R by the user (step S57), the process continues the processing to decode the channel A image information for video recording by using the second buffer capacity (½) and outputs it for image recording and also performs processing to decode the channel B image information by switching to the first buffer capacity and outputs it for image display (step S58).

The transitional operations in this case are specified as those for transition from step S37 to step S36 as shown in FIG. 3, so that transition processing peculiar to the embodiment of the present invention enables guaranteeing the continuity of an image being video-recorded while saving on the memory capacity of the frame buffer section by using the memory-reduced mode and, further, in one-screen display, enables high-quality image display without reducing the memory capacity.

In such a manner, by the decoding circuit related to one embodiment of the present invention, even in two-screen display, by performing transition due to a transition method specified in FIGS. 2 and 3 in response to a user's operation, a frame-buffer section's storage capacity using method is provided which can simultaneously realize reduction in memory capacity, continuity of an image being video-recorded, and high-image quality display.

As described above in detail, by the decoding circuit according to one embodiment of the present invention, when information is decoded in the ordinary decoding mode and being displayed on a screen, control is provided such that an output newly decoded in the memory-reduced mode may be used as an video recording output instead of a decoded output in the ordinary decoding mode. In such a manner, the decoding circuit according to one embodiment of the present invention can avoid a trouble of an image quality being deteriorated because the memory-reduced mode may be entered when newly decoding different contents and outputting them for display on a screen while continuing decoding for video recording output or can avoid a trouble of losing continuity of decoding for video recording output when decoding starts newly.

Further, by the decoding circuit according to one embodiment of the present invention, when transition is performed from the one-screen display mode to the two-screen display mode, by changing both of the decoding modes for decoded outputs used in display output to the memory-reduced mode, an ordinary memory capacity can be secured without fail when performing transition again from the two-screen display mode to the one-screen display mode even if either one of the decoded outputs used in the two-screen display mode is set for video recording output. It is thus possible in the decoding circuit according to one embodiment of the present invention to avoid a trouble of an image quality being deteriorated because new decoding for image display output is switched to decoding in the memory-reduced mode or a trouble of losing continuity of decoding for video recording output when new decoding starts.

Further, in the decoding circuit according to one embodiment of the present invention, when displaying two kinds of decoded images on two screens, an output obtained by decoding in the memory-reduced mode is used on both of the screens and control is provided so that an image obtained as a result of decoding in the memory-reduced mode is used as a video recording output. It is thus possible in the decoding circuit according to one embodiment of the present invention to, despite a plurality of decoding processing items, simultaneously realize a two-screen display function and a video recording output function while saving a memory capacity to a storage capacity of (memory size required in the ordinary decoding mode)+(memory size required in the memory-reduced decoding mode) without using twice the ordinary storage capacity as the storage capacity of the buffer memory required in the ordinary decoding mode.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A decoding circuit comprising:
a first decoding section which receive first compressed image information, decodes the information, and outputs decoded image information;
a second decoding section which receives the first compressed image information or second compressed image information, decodes the information, and outputs decoded image information;
a buffer section which stores the decoded image information in a storage region; and
a control section which responds to an instruction signal, if given, when the first decoding section is decoding the first compressed image information by using a storage region having a first capacity of storage regions of the buffer section and outputs it to a first output terminal, to thereby control the first decoding section and the second decoding section so that the second decoding section decodes and outputs the first compressed image information or the second compressed image information by using a storage region having a second capacity smaller than the first capacity of the storage regions of the buffer section.

2. The decoding circuit according to claim 1, wherein the control section responds to an instruction signal, if given, when the first decoding section is decoding the first compressed image information by using the storage region having the first capacity of the storage regions of the buffer section and outputting it to the first output terminal, to thereby control the first decoding section and the second decoding section so that the second decoding section decodes and outputs the first compressed image information by using the storage region having the second capacity smaller than the first capacity of the storage regions of the buffer section while the first decoding section continues the decoding processing and the outputting.

3. The decoding circuit according to claim 2, wherein, even if the first compressed image information supplied to the first decoding section is image information in accordance with a predetermined channel of an external tuner section and, later, image information of a channel different from the predetermined channel is supplied to the first decoding section, the control section provide control so that the second decoding section continues to decode and output the image information in accordance with the first predetermined channel.

4. The decoding circuit according to claim 1, wherein the control section responds to an instruction signal, if given, when the first decoding section is decoding the first compressed image information by using the storage region having the first capacity of the storage regions of the buffer section and outputting it to the first output terminal, to thereby control the first decoding section and the second decoding section so that the first decoding section decodes the first compressed image information by using the storage region having the second capacity of the buffer section and the second decoding section also decodes the second compressed image information by using the storage region having the second capacity of the buffer section.

5. The decoding circuit according to claim 4, wherein the control section responds to an instruction signal, if given, when the first decoding section is decoding the first compressed image information by using the storage region having the second capacity of the buffer section and the second decoding section is decoding the second compressed image information by using the storage region having the second capacity of the buffer section, to thereby provide control so that at least one of the image information decoded by the first decoding section and the second image information decoded by the second decoding section is output.

6. The decoding circuit according to claim 1, wherein the second capacity is half the first capacity.

7. The decoding circuit according to claim 1, wherein the first compressed image information is an MPEG stream and the first and second decoding sections perform MPEG decoding processing.

8. A decoding method for decoding compressed image information by using a storage region of a buffer section, the comprising:
decoding first compressed image information by using a storage region having a first capacity of storage regions of the buffer section and outputting it to a first output terminal; and
responding to an instruction signal, if given, during the above step, to thereby decode and output the first compressed image information or second compressed image information by using a storage region having a second capacity smaller than the first capacity of the storage regions of the buffer section.

9. The decoding method according to claim 8, further comprising:
if an instruction signal is given when the first compressed image information is being decoded by using the storage region having the first capacity of the storage regions of the buffer section and output to the first output terminal, decoding the first compressed image signal by using the storage region having a second capacity smaller than the first capacity of the storage regions of the buffer section and outputting it while continuing the decoding and outputting by use of the storage region having the first capacity.

10. The decoding method according to claim 9, wherein the first compressed image information is image information in accordance with a predetermined channel of an external tuner, and even if image information of a channel different from the predetermined channel is supplied later, the image information in accordance with the first predetermined channel continues to be decoded and output.

11. The decoding method according to claim 8, further comprising:
responding to an instruction signal, if given, when the first compressed image information is being decoded by using the storage region having the first capacity of the storage regions of the buffer section and output to the first output terminal, to thereby switch to decoding by use of the storage region having the second capacity, while further decoding the second compressed image information by using the storage region having the second capacity.

12. The decoding method according to claim 11, further comprising:
responding to an instruction signal, if given, when the first compressed image information is being decoded by using the storage region having the second capacity of the buffer section and the compressed image information is also being decoded by using the storage region having the second capacity of the buffer section, to thereby output at least one of decoded information of the first compressed image information and decoded image information of the second compressed image information.

13. The decoding method according to claim 8, wherein the second capacity is half the first capacity.

14. The decoding method according to claim 8, wherein the first compressed image information is an MPEG stream and undergoes MPEG decoding processing.
